(19) United States
(12) Patent Application Publication
(10) Pub. No.: US 2007/0214185 A1
(43) Pub. Date: Sep. 13, 2007

(54) Document management system, method and program therefor

(75) Inventor: Akihiko Fujiwara, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/373,227

(22) Filed: Mar. 10, 2006

(51) Int. Cl. G06F 17/30

(52) U.S. Cl. 707/200

(57) ABSTRACT

A document managing system and a method and program thereof are provided, which allow desired meta-data to be associated with a document to be managed in a simple manner. The system includes a related information acquisition unit for acquiring meta-data related to a predetermined process on a document to be managed, a setting unit for associating the meta-data acquired by the related information acquisition unit with the document, and a registration unit for registering the document and meta-data associated by the setting unit.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field Of The Invention

The present invention relates to a technique for managing documents and, more particularly, to a technique for applying meta-data to a document to be managed.

2. Description of the Related Art

Document managing systems have been known, in which arbitrary meta-data are associated with a document to be managed to manage the document based on the meta-data. In such a document managing system, for example, an electronic document (a file accompanied by an image) obtained by scanning an original document with an image reading apparatus can be managed by associating limited information as meta-data that can be collected from the image reading apparatus with the document.

In the above-described document managing system according to the related art, however, only information collectable from an apparatus related to the generation of an electronic document such as the above-described image reading apparatus can be associated with the electronic document as meta-data.

The invention was made to solve the above-described problem, and it is an object of the invention to provide a document managing system and a method and a program thereof which allow desired meta-data to be associated with a document to be managed in a simple manner.

### DESCRIPTION OF THE DRAWINGS

FIG. 1 is an illustration for schematically explaining a system configuration of a document managing system according to an embodiment;

FIG. 2 is a functional block diagram for explaining the document managing system according to the embodiment;

FIG. 3 is a flow chart for explaining a general flow of processes in the document managing system according to the embodiment;

FIG. 4 is a flow chart showing details of the processes in the document managing system according to the embodiment;

FIG. 5 shows an example of a GUI displayed by a display control unit 103;

FIG. 6 is an illustration for explaining a method of associating a document and meta-data;

FIG. 7 is a show chart showing a flow of security setting for a document in the document managing system according to the embodiment;

FIG. 8 shows an example of a GUI in such a case in which it is determined that a security setting is required; and

FIG. 9 is an illustration showing another example of the arrangement of elements constituting the document managing system according to the embodiment.

### DETAILED DESCRIPTION OF THE INVENTION

An embodiment of the invention will now be described with reference to the drawings.

Throughout this description, the embodiment and examples shown should be considered as exemplars, rather than limitations on the apparatus, methods and programs of the present invention.

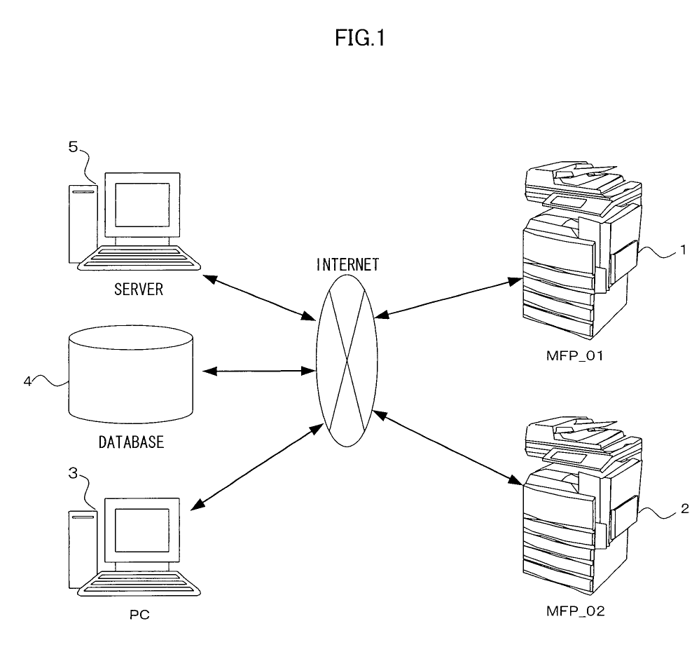

FIG. 1 is an illustration for schematically explaining a system configuration of a document managing system according to the present embodiment.

The document managing system according to the present embodiment is used in a network system as shown in FIG. 1. The network system in the figure is constituted by an MFP (Multi-Function Peripheral) 1 (MFP_{—}01), an MFP 2 (MFP_{—}2), a PC 3, a database 4, and a server 5.

The MFP 1, MFP 2, PC 3, database 4, and server 5 are connected through a telecommunication network such as the internet to be communicable with each other.

Each of the MFP 1 and MFP 2 has an image formation apparatus and an image reading apparatus, and they are therefore able to print an electronic document on a paper original document or the like with the image formation apparatus and to convert a paper document into an electronic document by scanning it with the image reading apparatus.

For example, the PC 3 is a computer possessed by a user at his or her home or the like. The database 4 comprises, for example, an HDD or the like and has the function of storing various types of information handled by the document managing system according to the present embodiment.

The MFP 1 and MFP 2 perform image processing such as image reading and image formation according to a request from the PC 3 or server 5 or based on operation inputs to the MFP 1 and MFP 2 from a user.

Although the means for connecting the MFP 1, MFP 2, PC 3, database 4, and server 5 with each other in a communicable manner is the internet here, it is not intended to put a limitation on the means, and a LAN, WAN or the like may alternatively be used (whether it is wired or wireless). The PC 3 may perform various setting processes for the database 4 and the server 5 based on operation inputs from a user.

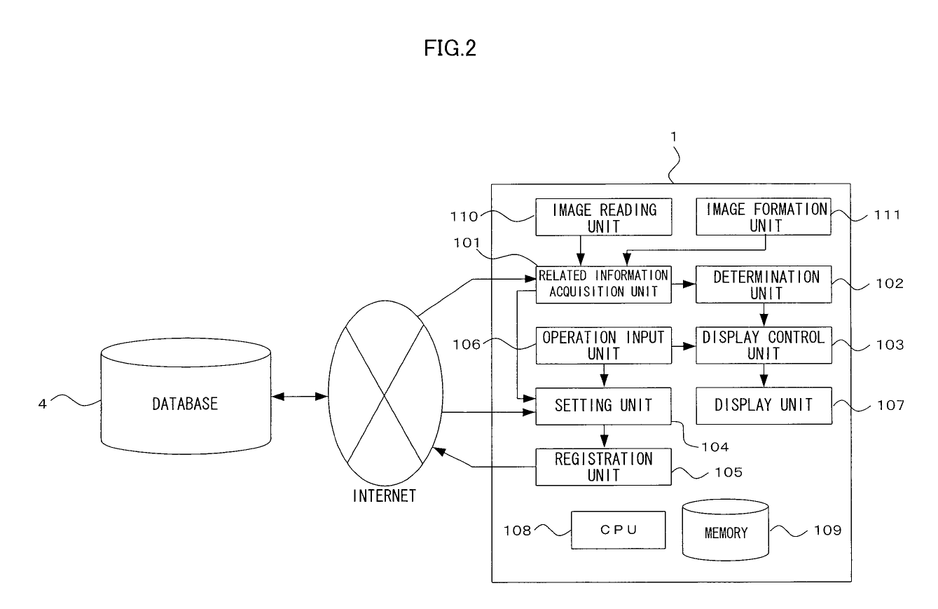

FIG. 2 is a functional block diagram for explaining the document managing system according to the present embodiment.

The document managing system according to the present embodiment has a configuration in which the MFP 1 incorporates a related information acquisition unit 101, a determination unit 102, a display control unit 103, a setting unit 104, a registration unit 105, an operation input unit 106, a display unit 107, a CPU 108, a memory 109, an image reading unit 110, and an image formation unit 111.

The image reading unit 110 has the function of reading an image of an original of a document (which is obtained by printing a document on paper) and performing an OCR process on the image thus read.

The related information acquisition unit 101 acquires meta-data related to a predetermined process on a document to be managed. The predetermined process means a process such as the image reading process performed by the image reading unit (image reading apparatus) 110 to read an image of an original of a document, the image formation process performed by the image formation unit (image formation apparatus) 111 to form an image on a sheet. The related information acquisition unit 101 can also acquire a character string acquired by the OCR process at the image reading unit 110 as meta-data. Further, the related information acquisition unit 101 can acquire the contents of an input accepted at the operation input unit 106 as meta-data related to a predetermined process on a document to be managed.

Based on the type of the meta-data acquired by the related information acquisition unit 101, the determination unit 102 determines whether it is required to make a setting for restraining a predetermined application from executing a predetermined process on the meta-data.

When plural items of meta-data are acquired by the related information acquisition unit 101, the display control unit 103 causes the display unit 107 serving as a display for providing screen display at the MFP 1 to display the plural items of meta-data such that desired meta-data can be selected.

The operation input unit 106 has the function of accepting an input of desired meta-data by a user and an operation input indicating a selection from among the plural items of meta-data displayed by the display control unit 103.

The setting unit 104 has the function of associating meta-data acquired by the related information acquisition unit 101 with a document. Specifically, the setting unit 104 associates meta-data selected from among the plural items of meta-data displayed on the screen by the display control unit 103 based on an operation input to the meta-data operation input unit 106 with a document.

When the determination unit 102 determines that it is required to make a setting for restraining a predetermined application from executing a predetermined process, the setting unit 104 can set a document to be associated with meta-data such that the predetermined application is restrained from executing the predetermined process on the document. As a result, when a document which has been scanned by a user is saved or processed otherwise, a security setting can be easily made for the document.

The registration unit 105 registers a document and meta-data associated with each other by the setting unit 104 in the database 4.

The CPU 108 has the function of performing various processes in the document managing system, and it also plays the role of providing various functions by executing programs stored in the memory 109. The memory 109 is constituted by, for example, a ROM, a RAM or the like, and it has the function of storing various types of information and programs used in the document managing system.

The display unit 107 is constituted by a liquid crystal display, a CRT display or the like, and it has the function of displaying the contents of processes performed by the document managing system. The operation input unit 106 is constituted by a keyboard, a mouse or the like, and it has the function of accepting operation inputs from a user. Obviously, the functions of the display unit 107 and the operation input unit 106 may alternatively be provided by a touch panel display or the like.

The database 4 is a module such as a file server having a document saving function, and it has the function of storing electronic data of a document to be managed as described above and meta-data associated with the electronic data. The term “electronic data of a document” means here electronic data of a document scanned at the MFP 1 or MFP 2 or electronic data of a document created in an electronic document processing environment. Referring to modes of management of electronic data carried out in the database 4, meta-data may be embedded in a document file using a mechanism for describing data in a file format such as PDF. Meta-data may alternatively be saved in an external database as a record of a table in which it is associated with an identifier of a relevant document.

Referring to information on documents managed in the database 4, it may be information on the positions where the documents are provided on the system (the information being managed, for example, as paths of a folder structure which depends on the file system). The information may be links (e.g., a link to each application form displayed on a top page of a company portal) or a structure for location depending on the contents of the documents (e.g., classification by categories). The database 4 also includes a system which provides a management structure for saving documents themselves.

Terms used in the present embodiment will now be described.

“The entity of a document” is the actual entity of an electronic document that depends on the form or format in which it is described. For example, in the case of a file system, the term applies to a file managed on the system. In the case of a document management system, the term applies to a data record saved in a database which manages an image on the system. The form or format may be TIFF, PDF or a form for saving unique to the document management system.

“Meta-data of a document” applies to attribute information or property information such as the creator of the document, the group to which the creator belongs, the location where the creator primarily resides, a user, the group to which the user belongs, the location where the user primarily resides, the date and time of creation, the weather at the time of creation, the environment of the creator at the time of creation, the date and time of use, the weather at the time of use, the environment of the user, and the application used for creation.

Hereinafter, a word separated by brackets means a name of meta-data, and a word separated by double quotes means the value or contents of meta-data.

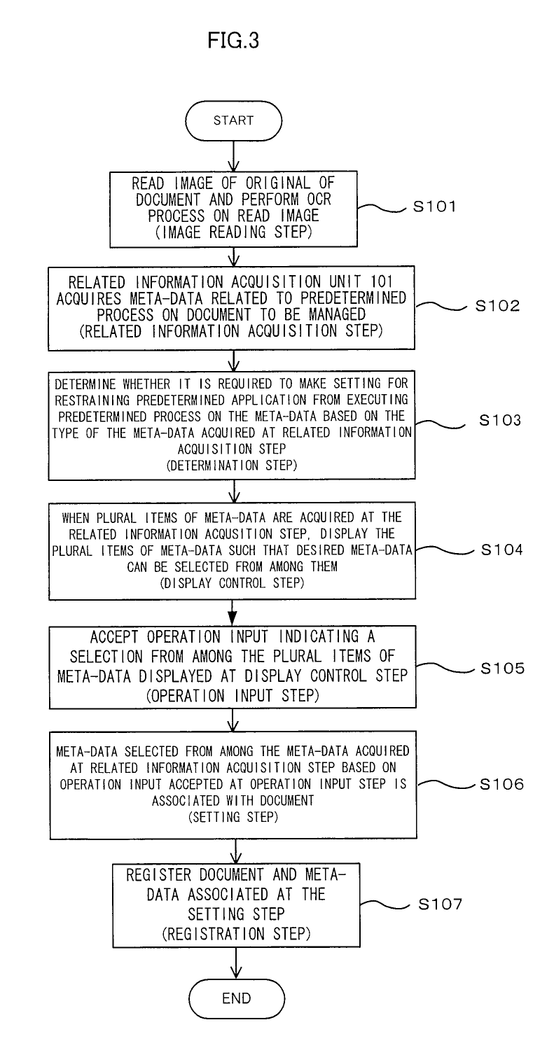

Next, a description will be made on a general flow of processes in the document managing system according to the present embodiment. FIG. 3 is a flow chart for explaining a general flow of processes in the document managing system according to the present embodiment. What is shown here by way of example is a flow of the processes of scanning an original of a document at the MFP 1 and imparting desired meta-data to an electronic document obtained as a result of the scan.

The image reading unit 110 reads an image of the document original and performs an OCR process on the read image (image reading step) (S101). Obviously, an image formation process may be performed by the image formation unit 111 at this stage.

The related information acquisition unit 101 acquires meta-data related to predetermined processes on the document to be managed (the image reading process performed when the image on the document original is read by the image reading unit 110 and the image formation process performed when the image on the document is formed on a sheet by the image formation unit 111) (related information acquisition step) (S102). At the related information acquisition step, a character string acquired by the OCR process at the image formation step may be acquired as meta-data, and the contents of an input accepted at an operation input step may be acquired as meta-data related to a predetermined process on the document to be managed.

Based on the type of the meta-data acquired at the related information acquisition step, the determination unit 102 determines whether it is required to make a setting for restraining a predetermined application from executing a predetermined process on the meta-data (determination step) (S103).

When plural items of meta-data are acquired at the related information acquisition step, the display control unit 103 causes the plural items of meta-data to be displayed such that desired meta-data can be selected (display control step) (S104).

The operation input unit 106 accepts an operation input indicating a selection from among the plural items of meta-data displayed at the display control step (operation input step) (S105).

The setting unit 104 associates the meta-data selected from among the meta-data acquired at the related information acquisition step based on the operation input accepted at the operation input step with a document (setting step) (S106). When only one item of meta-data is acquired at the related information acquisition step, the setting unit 104 automatically associates the meta-data with the document. When the determination step determines that it is required to make a setting for restraining a predetermined application from executing a predetermined process, the setting step makes a setting for the document with which the meta-data is to be associated such that the predetermined application is restrained from executing the predetermined process on the same.

The registration unit 105 registers the document and meta-data associated with each other at the setting step (registration step) (S107).

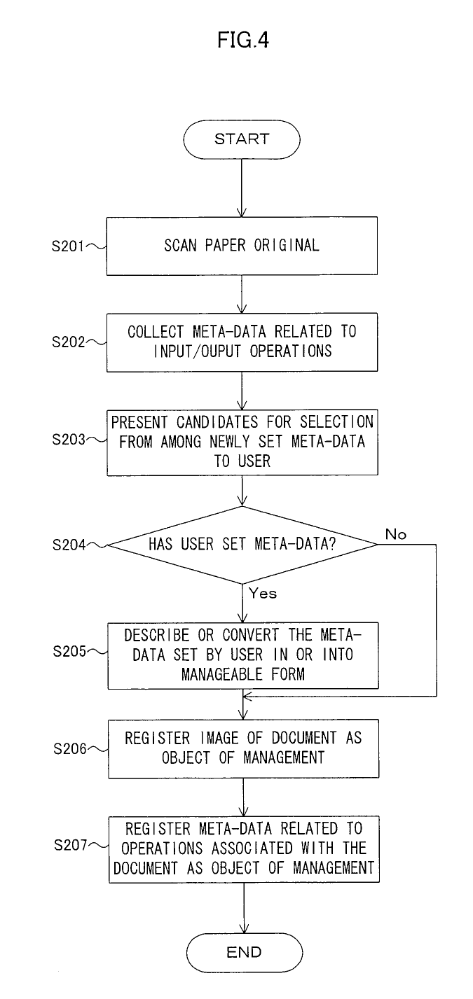

Next, details of the processes in the document managing system according to the present embodiment will be described with reference to a specific example. FIG. 4 is a flow chart showing details of the processes in the document managing system according to the present embodiment.

First, a user scans a paper original document at least at either of the MFP 1 and the MFP 2 (S201). The related information acquisition unit 101 collects meta-data at this operation (S202). Referring to the meta-data, for example, “XXXtaro” is collected as a value indicating who has performed the scanning operation, for example, as [creator] who has performed the operation or created a new electronic document through the scanning operation. The date and time of the scanning operation are collected as a value “Sep. 16, 2005 14:30:10” of meta-data [date and time of creation]. Since the MFP itself recognizes the identity of the apparatus at which the operation was performed from a value set in itself, a value “MFP_{—}01” of meta-data [operating apparatus] is collected.

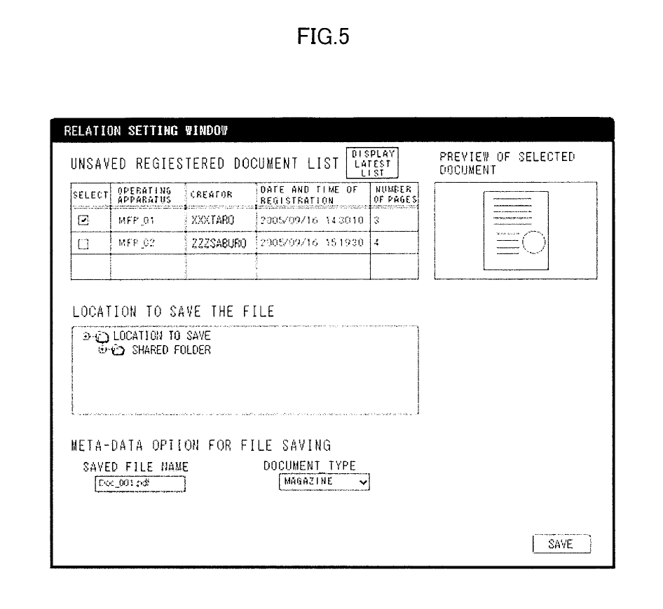

The display control unit 103 causes the display unit 107 to display a GUI on which the meta-data acquired by the related information acquisition unit 101 can be displayed or input as well as meta-data that can be newly set (S203). FIG. 5 shows an example of the GUI displayed by the display control unit 103. First, the GUI displays an “unsaved registered document list” in the form of a table listing documents which have been scanned at the MFP and have not been saved as document entities yet. The meta-data collected at the related information acquisition unit 101 are also displayed on the table, and a user can find a document to be saved by looking at the information. It is assumed here that XXXtaro specifies that the document scanned and registered at MFP_{—}01 is to be saved in a PDF file. The user operates the operation input unit 106 to select the document of interest from the list. This GUI provides a preview of an image of the document on the right side of the table at the time of selection to allow a further check on whether the correct document has been selected or not.

The user can specify the location to save the document by developing a folder tree of “location to save file” and making a selection from among them. Further, [saved file name] and [document type] can be set as the meta-data other than the meta-data collected by the related information acquisition unit 101. A file name can be set from the GUI as [saved file name] when the file entity is saved in the database 4. The type of the scanned image can be set as [document type].

Values selectable as [document type] include “meeting material”, “writing on blackboard”, “magazine”, and so on. When the user sets those meta-data (Yes at S204), the meta-data thus set are saved in a form which can be managed in the database 4. In this example, since the meta-data are saved by describing it in a PDF file that is a document entity, the data are converted into a form which can be described in the file (S205). The user can save the file as a document entity in the database 4 by depressing a “save” button after setting those values (S206).

The image of the paper original document scanned at the MFP is thus registered in the database 4, and the meta-data collected by the related information acquisition unit 101 and the meta-data set by the user at the operation input unit 106 are managed in the database 4 (S207). The [saved file name] and the [document type] set by the user are managed in the database 4 (see FIG. 5).

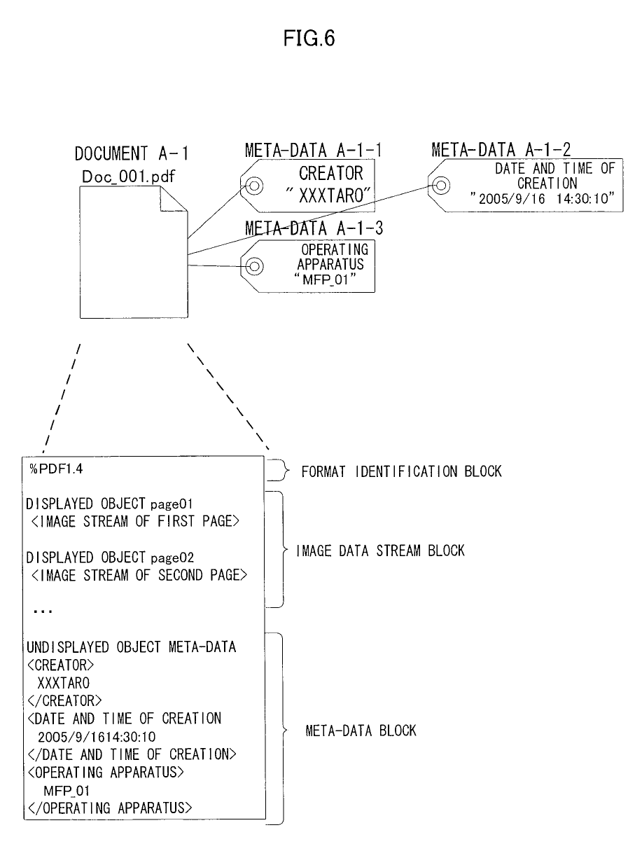

Referring to the method of managing a document in the server 4, a method is employed, in which a scanned image is processed into a PDF file and meta-data are stored in the file (see FIG. 6). As shown in the same figure, what is described in the file entity is a block identifying the format of the file, a block of streams describing input image data as PDF page data, a block which is embedded as data although not displayed by a viewer, and so on. An image of each original page which has been scanned is described as an image stream constituting one page of the PDF, and the process is repeated a number of times corresponding to the number of sheets of the paper original document which have been scanned. The meta-data thus collected are described as XML streams for a data area which is not displayed as an image. That is, the setting unit 104 associates meta-data with a document by incorporating the meta-data to be associated in the document,

The name “XXXtaro” of the user who has logged in to perform a scanning operation is substituted as a value for [creator], and “Sep. 16, 2005 14:30:10” that is the date and time of the scanning operation is substituted as a value for [date and time of creation]. The identification name “MFP_{—}01” assigned to the multi-function copier having an input device at which the scanning operation has been performed is substituted as a value for [operating apparatus].

Obviously, the method of associating the data of an electronic document with meta-data is not limited to this. Alternatively, an XML file having the data described therein may be managed or the meta-data may be saved as a record in a table of the database.

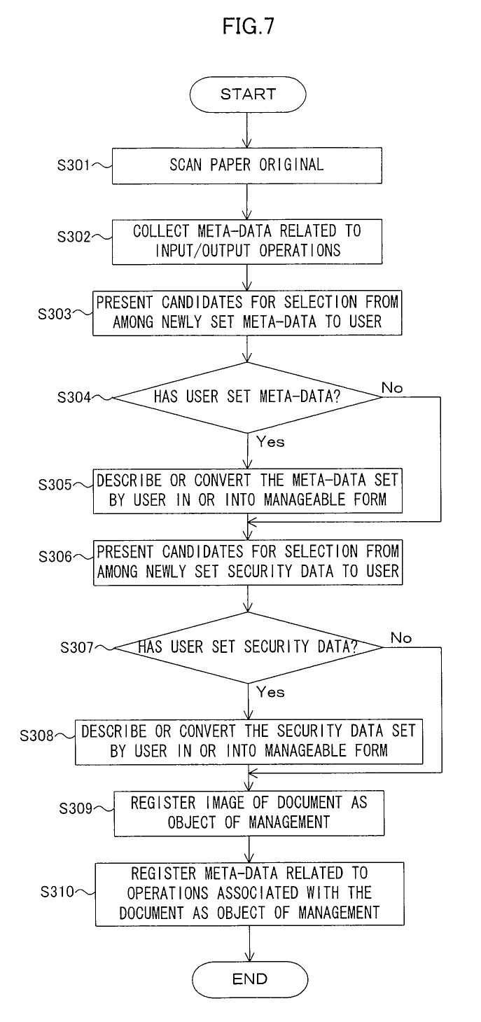

Next, a description will be made on a security setting for a document in the document managing system according to the present embodiment. FIG. 7 is a flow chart showing a flow of security setting for a document in the document managing system according to the present embodiment. The description will omit S301 to S305 in the flow chart shown in the same figure because they are similar to S201 to S205 in the flow chart shown in FIG. 4.

When words such as “meeting material”, “confidential”, “important”, and “patent” are included in meta-data acquired by the related information acquisition unit 101, the determination unit 102 determines that the relevant document is a document which may require a security setting. The meta-data acquired by the related information acquisition unit 101 in this case include information that a user selects and inputs by operating a GUI or keyboard by him- or herself.

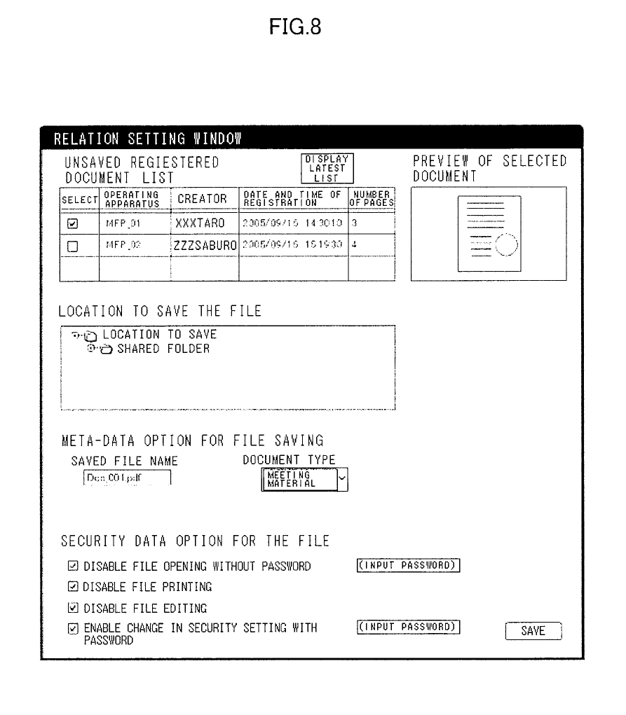

In this case, the display control unit 103 causes the display unit 107 to display a GUI which allows security data to be displayed and input (S306). FIG. 8 shows an example of a GUI in such a case in which it is determined that a security setting is required.

What is shown here is an example in which a screen for setting security data options for a file is displayed. First, the GUI allows a security option “disable file opening without a password” to be specified. This is a setting for prompting the user to input a password to open the document entity using an application when the new document is saved as Doc_{—}001.pdf. In this case, a PDF file format is employed as the document entity, and an optional setting is made to utilize a security function of AcrobatReader (registered trademark) which requests a password when the PDF file is opened using AcrobatReader or the like.

When it is desired to make this optional setting, the user inputs a character string of a password with a check box selected to enable this setting. When it is desired to enable an option to disable file printing or file editing using a security function of AcrobatReader similarly, a check box is selected to enable the setting. Applications such as Acrobat (registered trademark) have a password setting function to allow a security setting to be edited when an owner password is input after the setting is once made. When it is desired to set this password, the owner password is set after selecting a check box for an “enable a change in security setting with password” option.

When the determination unit 102 determines that there is no need for making a security setting (e.g., when the acquired meta-data is “magazine”), a GUI as shown in FIG. 5 is displayed.

When such security data are set by the user (Yes at S307), data are described to make such a setting for the PDF file entity that is the finally saved file (S308). Then, the registration unit 105 registers an image of the document in the database 4 as a document entity (S309). Finally, the registration unit 105 registers the meta-data in the database 4 (S310).

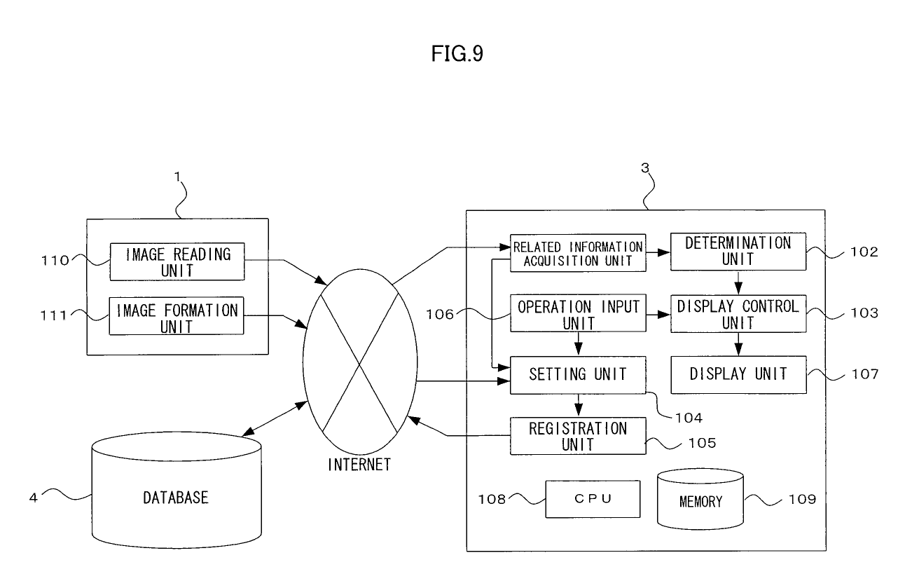

Although the above-described embodiment represents an example in which all elements constituting the document managing system according to the present embodiment are provided in an MFP, the example is not shown in a limiting sense. For example, as shown in FIG. 9, a configuration may be employed, in which the image reading unit 110 and the image formation unit 111 are provided in the MFP 1 and in which other constituent elements, i.e., the related information acquisition unit 101, the determination unit 102, the display control unit 103, the setting unit 104, the registration unit 105, the operation input unit 106, the display unit 107, the CPU 108, and the memory 109 are provided in the PC 3. Obviously, the document managing system can provide the same advantage as the above-described configuration also when configured in such a way.

As thus described, as long as the elements constituting the document managing system according to the present embodiment are communicable with each other, the location of each element does not matter, and what is required in consequence is that all of the elements constituting the document managing system are provided.

Each of the steps of the above-described process in the document managing system is achieved by causing the CPU 108 to execute a document managing program stored in the memory 109.

Although the present embodiment has been described with reference to a case in which the functions embodying the invention are recorded in advance in the apparatus, the description does not have a limiting sense. Alternatively, similar functions may be downloaded from a network to the apparatus, or similar functions stored in a recording medium may be installed in the apparatus. The recording medium may be in any form as long as it is a recording medium such as a CD-ROM in which programs can be stored and which can be read by the apparatus. The functions installed or downloaded in advance as thus described may be achieved in cooperation with an OS (operating system) or the like in the apparatus.

As described above, when a predetermined process such as an image reading process, image formation process, or an editing process is performed on a document to be managed, the present embodiment allows information related to the contents of the process to be associated with the document easily. As a result, a variety of meta-data can be easily imparted to a document, which allows a contribution to be made to an improvement in the convenience of document management.

In the case of a document managing system according to the related art, when it is desired to make a predetermined security setting for a document to be managed, it has been difficult to set the security setting based on information other than information that can be collected from an apparatus such as an image reading apparatus involved in the generation of the electronic document. In the present embodiment, a security setting can be easily made for a document to be managed based on desired meta-data.

The invention has been described in detail with reference to a specific mode of the same, and it will be apparent to those skilled in the art that various alterations and modifications may be made as long as they do not depart from the spirit and scope of the invention.

As described above in detail, the invention makes it possible to provide a document managing system and a method and a program thereof which allow desired meta-data to be associated with a document to be managed in an simple manner.

It is claimed:

1. A document managing system comprising:
a related information acquisition unit that acquires meta-data related to a predetermined process on a document to be managed;
a setting unit that associates the meta-data acquired by the related information acquisition unit with the document; and
a registration unit that registers the document and meta-data associated by the setting unit.

2. A document managing system according to claim 1, wherein the related information acquisition unit acquires information related to an image reading process when the image reading is performed on the original of the document by an image reading apparatus or information related to an image formation process when the formation of an image of the document is performed on a sheet by an image formation apparatus as the meta-data.

3. A document managing system according to claim 1, comprising:
a display control unit that causes plural items of meta-data to be displayed such that desired meta-data can be selected from among them when there are plural items of meta-data acquired by the related information acquisition unit; and
an operation input unit that accepts an operation input indicating a selection from among the plural items of meta-data displayed by the display control unit,
wherein the setting unit associates the selected meta-data with the document based on the operation input to the operation input unit.

4. A document managing system according to claim 1, wherein:
the operation input unit accepts an input of desired meta-data by a user; and
the related information acquisition unit acquires the contents of the input accepted by the operation input unit as meta-data related to a predetermined process on the document to be managed.

5. A document managing system according to claim 1, comprising:
an image reading unit capable of reading an image of an original of a document and performing an OCR process on the read image, wherein the related information acquisition unit acquires a character string acquired by the OCR process at the image reading unit as meta-data.

6. A document managing system according to claim 1, wherein the setting unit sets the document such that a predetermined application is restrained from executing a predetermined process on the document with which the meta-data are to be associated.

7. A document managing system according to claim 6, comprising:
a determination unit that determines whether it is required to make a setting for restraining a predetermined application from executing a predetermined process on the meta-data based on the type of the meta-data acquired by the related information acquisition unit, wherein the setting unit makes the setting when the determination unit determines that it is required to make the setting for restraining the predetermined application from executing the predetermined process.

8. A document managing system according to claim 1, wherein the setting unit performs association by incorporating the meta-data to be associated with the document in the document.

9. A document managing system according to claim 1, wherein the display control unit causes the meta-data to be displayed on a display for providing screen display at an image processing apparatus.

10. A document managing method comprising:
a related information acquisition step that acquires meta-data related to a predetermined process on a document to be managed;
a setting step that associates the meta-data acquired at the related information acquisition step with the document; and
a registration step that registers the document and meta-data associated at the setting step.

11. A document managing method according to claim 10, wherein the related information acquisition step acquires information related to an image reading process when the image reading is performed on the original of the document by an image reading apparatus or information related to an image formation process when the formation of an image of the document is performed on a sheet by an image formation apparatus as the meta-data.

12. A document managing method according to claim 10, comprising:
a display control step that causes plural items of meta-data to be displayed such that desired meta-data can be selected from among them when there are plural items of meta-data acquired at the related information acquisition step; and
an operation input step that accepts an operation input indicating a selection from among the plural items of meta-data displayed at the display control step, wherein the setting step associates the selected meta-data with the document based on the operation input accepted at the operation input step.

13. A document managing method according to claim 10, comprising:
an image reading step capable of reading an image of an original of a document and performing an OCR process on the read image, wherein the related information acquisition step acquires a character string acquired by the OCR process at the image reading step as meta-data.

14. A document managing program for causing a computer to execute:
a related information acquisition step that acquires meta-data related to a predetermined process on a document to be managed;
a setting step that associates the meta-data acquired at the related information acquisition step with the document; and
a registration step that registers the document and meta-data associated at the setting step.

15. A document managing program according to claim 14, wherein the related information acquisition step acquires information related to an image reading process when the image reading is performed on the original of the document by an image reading apparatus or information related to an image formation process when the formation of an image of the document is performed on a sheet by an image formation apparatus as the meta-data.

16. A document managing program according to claim 14, comprising:
a display control step that causes plural items of meta-data to be displayed such that desired meta-data can be selected from among them when there are plural items of meta-data acquired at the related information acquisition step; and
an operation input step that accepts an operation input indicating a selection from among the plural items of meta-data displayed at the display control step, wherein the setting step associates the selected meta-data with the document based on the operation input accepted at the operation input step.

17. A document managing program according to claim 14, wherein:
the operation input step accepts an input of desired meta-data by a user; and
the related information acquisition step acquires the contents of the input accepted at the operation input step as meta-data related to a predetermined process on the document to be managed.

18. A document managing program according to claim 14, comprising:
an image reading step capable of reading an image of an original of a document and performing an OCR process on the read image, wherein the related information acquisition step acquires a character string acquired by the OCR process at the image reading step as meta-data.

19. A document managing program according to claim 14, wherein the setting step sets the document such that a predetermined application is restrained from executing a predetermined process on the document with which the meta-data are to be associated.

20. A document managing program according to claim 19, comprising:
a determination step that determines whether it is required to make a setting for restraining a predetermined application from executing a predetermined process on the meta-data based on the type of the meta-data acquired at the related information acquisition step, wherein the setting step makes the setting when the determination step determines that it is required to make the setting for restraining the predetermined application from executing the predetermined process.
